(19) United States
(12) Patent Application Publication
(10) Pub. No.: US 2005/0086842 A1
(43) Pub. Date: Apr. 28, 2005

(54) Portable display device

(75) Inventors: Scott Ternovits, Chicago, IL (US); Jonathan Fairman, Columbia, MO (US); Andrew Manocheo, Chicago, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 10/691,817

(22) Filed: Oct. 23, 2003

(51) Int. Cl. G09F 1/08

(52) U.S. Cl. 40/539

(57) ABSTRACT

A portable display device and method of setting up the portable display device. The display device includes first and second panels that can fold inwardly relative to each other. The device may also include a marquee surface integral with the display device that extends outwardly from the first and second panels, and a footer integral with the display device that extends away from the first and second panels. First and second bottom braces can also be integral with and movably coupled to the first and second panels, respectively.

### FIELD OF THE INVENTION

The invention relates to display products, and more particularly to portable display devices that are commonly used when giving a presentation.

### BACKGROUND OF THE INVENTION

Portable display devices are useful to transport and display a variety of information, such as business information, advertising information, and educational information. However, known display systems can be complex and/or lack the desired stability to ensure an effective presentation.

### SUMMARY OF THE INVENTION

The present invention provides a portable display device for use in any number of different applications. More specifically, the invention provides a portable display device comprising a first panel having a front surface and a rear surface, and a second panel movably coupled to the first panel, the second panel having front and rear surfaces. The display device also includes a marquee surface integral with the first and second panels such that when the first and second panels are coplanar, the marquee surface is substantially coplanar with the first panel and second panel. When the first and second panels are angled with respect to each other, the marquee surface can be pushed out of the plane and project away from the first and second panels.

In one embodiment, the display device further includes a third panel coupled between the first and second panels. Preferably, the first and second panels can fold inwardly over the third panel such that when the first and second panels are folded inwardly, they overlap each other.

The invention also provides a portable display device comprising a first panel, a second panel, and third panel coupled between the first and second panels such that the first and second panels are each movably coupled to the third panel. The display device also includes a footer integral with and movably coupled to the third panel.

In one embodiment, a first bottom brace integral with and movably coupled to the first panel, and a second bottom brace integral with and movably coupled to the second panel. In another embodiment, the display device comprises one piece of material, and the one piece of material is rectangular such that the length of the first panel plus the first bottom brace is equal to the length of the third panel plus the footer.

The invention also defines a method for setting up a portable display device formed of a single piece of material. The method includes folding a first panel of the material inwardly toward a center of the material along a first side hinge line, and folding a second panel of the material inwardly toward the center of the material along a second side hinge line. The method also includes extending a marquee surface away from the first and second panels, extending a footer away from the first and second panels along a footer hinge line, extending a first bottom brace away from the first panel along a first lower hinge line in the second direction, and extending a second bottom brace away from the second panel along a second lower hinge line in the second direction.

Other features and advantages of the invention will become apparent to those skilled in the art upon review of the following detailed description, claims, and drawings.

### BRIEF DESCRIPTION OF THE DRAWINGS

FIG. 1 is a front view of a portable display device embodying the invention, shown in the manufactured position.

FIG. 2 is a perspective view of the portable display device of FIG. 1 in the folded position.

FIG. 3 is a perspective view of the portable display device of FIG. 1 in the operative position.

FIG. 4 is a top view of the portable display device of FIG. 3.

FIG. 5 is an alternative portable display device according to the present invention.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including,” “having,” and “comprising” and variations thereof herein is meant to encompass the items listed thereafter and equivalents thereof as well as additional items.

### DETAILED DESCRIPTION

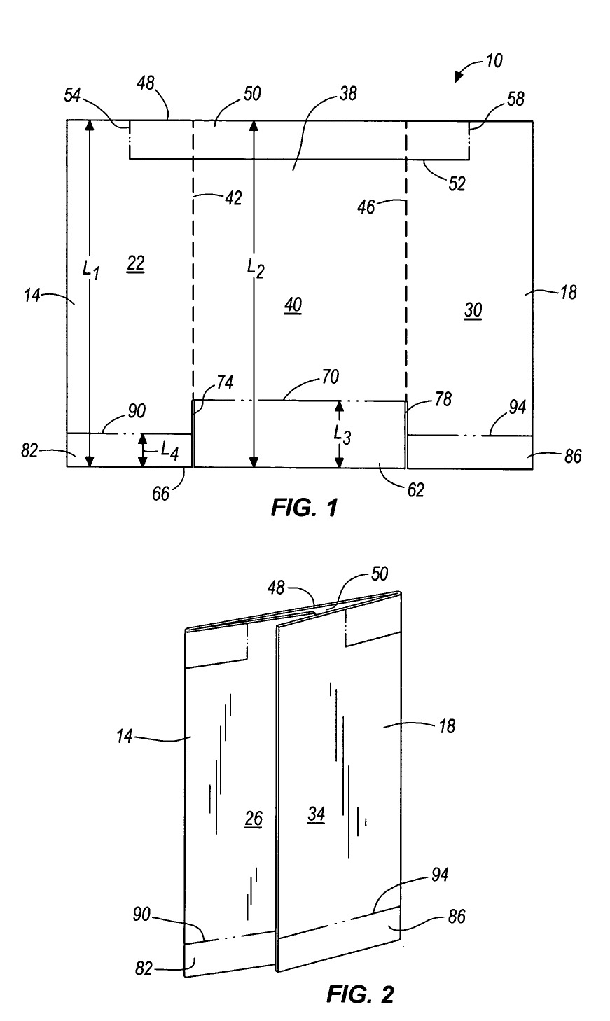

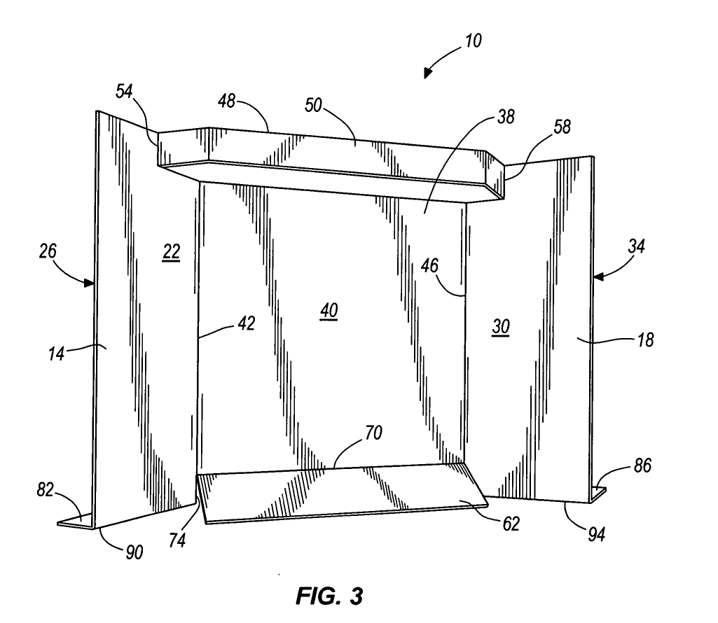

FIG. 1 illustrates a portable display device 10 for displaying information. The display device 10 of FIG. 1 is shown in the manufactured position and includes a first panel 14 and a second panel 18. Each of the first and second panels 14, 18 has a front surface 22, 30 and a rear surface 26, 34 (see FIG. 2), respectively.

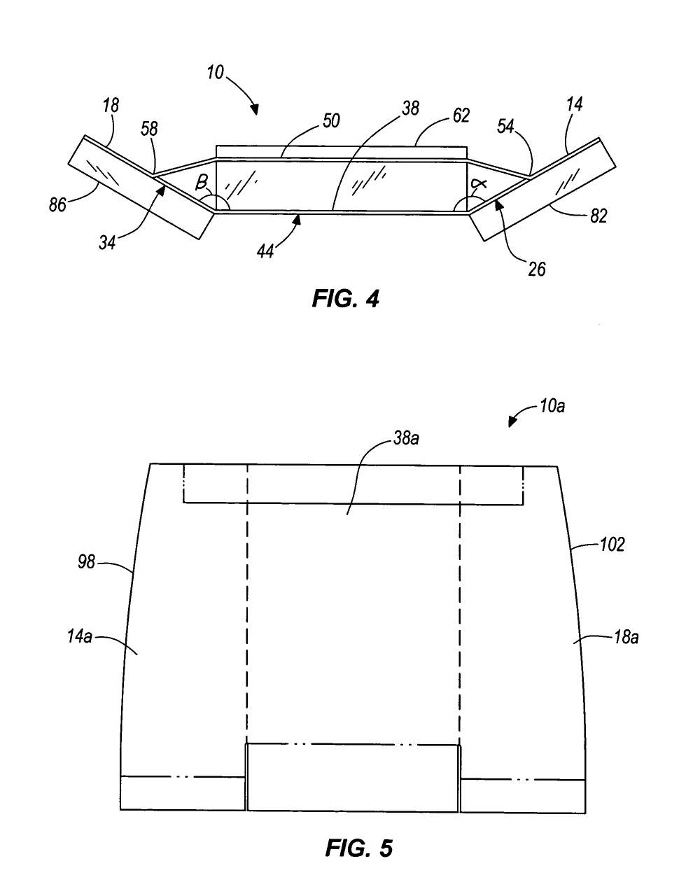

The first panel 14 is movably coupled to the second panel 18 via a third panel 38. The third panel 38 also includes a front surface 40 and a rear surface 44 (see FIG. 4). It should be understood that while three panels are shown in the illustrated embodiment, the display device may have two panels, four panels, or any desired number of panels and still fall within the scope of the present invention.

The first panel 14 is coupled to the third panel 38 along a first side hinge line 42 to permit relative movement between the panels. The second panel 18 is coupled to the third panel 38 along a second side hinge line 46 to permit relative movement between the panels. In the illustrated embodiment, the side hinge lines 42, 46 include a cut extending through either the front or rear surface of the first panel 14. However, it is understood that in other embodiments, the side hinge lines may include a deformed area (also known as a crush score) that does not include any cuts.

The display device 10 also includes a marquee surface 50 integral with the display device 10. In the illustrated embodiment, the marquee surface 50 is located near the top 48 of the display device 10. The panels 14, 18, 38 include a cut 52 through the display device 10 (i.e., through both the front and rear surfaces of the panels 14, 18, 38). The first panel 14 includes a first upper hinge line 54, and the second panel 18 includes a second upper hinge line 58. As illustrated, the upper hinge lines 54, 58 include a crush score, although it is understood that the upper hinge lines 54, 58 could also include a cut through one of the front or rear surfaces. The cut 52 and the upper hinge lines 54, 58 allow the marquee surface 50 to project away from the display device 10.

The marquee surface 50 can be used as a featured display area for bibliographical and other data relating to the information displayed on display device 10. The marquee surface 50 can either be integrally formed with the display device 10 (as in the illustrated embodiment), or it can be formed from a different piece of material and be permanently attached to the display device 10.

It is understood that in other embodiments (not shown), the marquee surface 50 can be located in any desired position along the height of the display device 10. For example, the marquee surface 50 could be located near the middle or the bottom of the display device 10. It is also understood that while the marquee surface 50 is generally centered on the third panel 38 of the display device 10 in the illustrated embodiment, the marquee surface 50 may be positioned in any desired position along the first, second, or third panels 14, 18, 38 and still fall within the scope of the present invention.

As shown in FIG. 1, when the first, second, and third panels 14, 18, 38 are in a coplanar relationship with respect to each other (i.e., the manufactured position), the marquee surface 50 is also substantially coplanar with the panels 14, 18, 38. When the first and second panels 14, 18 are angled with respect to one another (the operative position of the display device 10—see FIGS. 3 and 4), the marquee surface 50 can be pushed out of the plane of the panels 14, 18, 38. In the present embodiment, the marquee surface 50 projects outwardly from the front surfaces 22, 30, 40 of the panels 14, 18, 38, but it is understood that in other embodiments, the display surface could project rearwardly from the panels 14, 18, 38 and still fall within the scope of the present invention.

The illustrated display device 10 also includes a footer 62 integral with at least one of the panels 14, 18, 38. As shown in FIG. 1, the third panel 38 includes a footer hinge line 70 including a crush score. The footer 62 is movable with respect to the third panel 38 along the footer hinge line 70. A portion of the side hinge lines 42, 46 include a cut 74, 78 through both the front and rear surfaces of the first and second panels 14, 18, respectively, to allow the footer 62 to project away from the display device 10.

The footer projects away from the bottom 66 of the display device 10 to provide both support for the display device 10 and to provide another featured display area. In the illustrated embodiment, the footer 62 is integral with the third panel 38. In some embodiments (not shown), the marquee surface 50 could be located at the bottom 66 of the display device 10 to provide additional support as well as the featured display area, thereby providing the function of both the footer 62 and the marquee surface 50.

The illustrated display device 10 also includes a first and a second bottom brace 82, 86 integral with the display device 10 to further increase the stability of the display device 10 when it is set up. As illustrated in FIG. 1, the first panel 14 includes a first lower hinge line 90 that allows the first bottom brace 82 to move relative to the first panel 14. The first lower hinge line 90 includes a crush score. The second panel 18 also includes a second lower hinge line 94 to allow the second bottom brace 86 to move relative to the second panel 18.

Generally, the footer 62 will extend away from the display device 10 in one direction and the bottom braces 82, 86 will extend away from the display device 10 in the opposite direction as this arrangement provides the most support for the display device 10. In the embodiment shown in FIG. 2, the footer 62 projects forwardly from the front surface 40 of the third panel 38, and the bottom braces 82, 86 project rearwardly from the first and second panels 14, 18, respectively.

The illustrated display device 10 formed of corrugated cardboard. It is understood, however, that the panels could be formed of other materials, such as reinforced paper, plastic, wood, corkboard, chalkboard, etc. In the illustrated embodiment, the front and rear surfaces of the panels 14, 18, 38 include a dry erase surface for easily adding and removing information. The composition of such a dry erase surface is well-known in the industry. In addition, the front and rear surfaces may also comprise magnetic material, compressed foam, corkboard, or other suitable display surfaces.

As shown in FIG. 1, the display device 10 comprises one piece of material (in the illustrated example, corrugated cardboard). The one piece of material may be a unitary blank of material, or it may comprise individual pieces of material coupled (e.g., glued, stapled, or otherwise fastened) together. In the manufactured position, the one piece of material is generally rectangular in shape such that when the first bottom brace 82, the second bottom brace 86, and the footer 62 are coplanar with the first, second, and third panels 14, 18, 38, respectively, the length L₁ of the first panel 14 plus the first bottom brace 82 is equal to the length L₂ of the third panel 38 plus the footer 62. The length L₃ of the footer 62, is approximately equal to twice then length L₄ of the first bottom brace 82.

As illustrated in FIG. 2, the widths of the panels 14, 18, 38 are such that the first and second panels 14, 18 can fold inwardly over the third panel 38. This folded position makes the display device 10 more portable for transport. When the first and second panels 14, 18 are in the folded position, the panels 14, 18 overlap each other. The overlap of the panels 14, 18 provides complete protection of the front display surfaces of the panels 14, 18, 38 during transport of the display device 10. It is understood that in other embodiments (not shown), the width of the panels may be such that folding the first and second panels 14, 18 over the third panel 38 results in a coplanar relationship between the panels 14, 18.

FIGS. 3 and 4 illustrate the display device 10 in the operative position after it has been set up for use in displaying information. For example, the display device 10 may be used by a student in a science fair, by a business at a trade show to display marketing and other business information, or for many other uses. The display device 10 provides an aesthetically pleasing and stable display surface that is also easily transportable. To set up the display board, a user begins by folding the first panel 14 inwardly along the first side hinge line 42 toward the center of the display device 10 to a desired display angle α. The preferred display angle is generally between one hundred twenty and one hundred sixty degrees, although it is understood that any angle between zero and three hundred sixty degrees may be used.

The user then folds the second panel 18 inwardly along the second side hinge line 46 toward the center of the display device 10 at a display angle is approximately equal to the display angle α for the first panel 14. It is understood that while in some embodiments the first and second panels 14, 18 will have equal display angles α and β, respectively, in other embodiments it may be desirable to have the first and second panels 14,18 positioned at different display angles.

The user next extends the marquee surface 50 away from the panels 14, 18, 38. As shown in FIG. 2, the marquee surface 50 extends forwardly of the front surfaces 22, 30, 40 of the panels 14, 18, 38. The footer 62 is then extended away from the third panel 38 along the footer hinge line 70 in a first direction (as shown in FIG. 2, forwardly from the third panel 38). The user can then extend the bottom braces 82, 86 away from the first and second panels 14, 18, respectively, along the first and second lower hinge lines 90, 94 in a second direction (i.e., rearwardly from the first and second panels 14, 18).

FIG. 5 illustrates an alternative display device 10a in the manufactured position according to the present invention. Like parts are given the reference numeral “a”.

Similar to what is described above for FIG. 1, the display device 10a includes a first panel 14a, a second panel 18a, and a third panel 38a. The first and second panels 14a, 18a include outer sides 98, 102 that are at least partially curved. In the illustrated embodiment, the outer sides 98, 102 are curved near the top of the first and second panels 14a, 18a, respectively. However, it is understood that the first and second panels 14a, 18a may be curved along any part of, or along the entirety of, the outer sides 98, 102.

When the display device 10a is in the folded position (similar to FIG. 2 described above), a portion of the first and second panels 14a, 18a may overlap (e.g., the non-curved portion) while another portion of the first and second panels (e.g., the curved portion) will not. The remaining parts and set up of the display device 10a is the same as is described above with respect to FIGS. 1, 3, and 4 and will not be discussed again here.

Various features of the invention are set forth in the following claims.

1. A portable display device comprising:
a first panel having a front surface and a rear surface;
a second panel movably coupled to the first panel and having a front surface and a rear surface; and
a marquee surface integral with the first and second panels such that when the first and second panels are coplanar, the marquee surface is substantially coplanar with the first and second panels, and when the first and second panels are angled with respect to one another, the marquee surface can be pushed out of the plane and project away from the first and second panels.

2. The portable display device of claim 1, further including a third panel coupled between the first and second panels such that the first panel is movably coupled to the third panel and the second panel is movably coupled to the third panel.

3. The portable display device of claim 2, wherein the first and second panels can fold inwardly over the third panel, such that when the first and second panels are folded inwardly, the first and second panels overlap each other.

4. The portable display device of claim 1, wherein the first panel is separated from the second panel by a side hinge line to permit relative movement between the panels.

5. The portable display device of claim 4, wherein the side hinge line includes a deformed area.

6. The portable display device of claim 4, wherein the side hinge line includes a cut extending through one of the front or rear surfaces of the first and second panels.

7. The portable display device of claim 1, wherein the marquee surface is located at a top of the first and second panels.

8. The portable display device of claim 1, wherein the marquee surface projects outwardly from the front surfaces of the first and second panels.

9. The portable display device of claim 1, wherein outer sides of the first and second panels are at least partially curved.

10. The portable display device of claim 1, further comprising a footer integral with and movably coupled to at least one of the first and second panels.

11. A portable display device comprising:
a first panel;
a second panel;
a third panel coupled between the first panel and the second panel such that the first panel is movably coupled to the third panel and the second panel is movably coupled to the third panel, each of the first, second, and third panels having a front surface and a rear surface; and
a footer integral with and movably coupled to the third panel.

12. The portable display device of claim 11, further comprising a first bottom brace integral with and movably coupled to the first panel, and a second bottom brace integral with and movably coupled to the second panel.

13. The portable display device of claim 12, wherein the first panel includes a first lower hinge line, and wherein the first bottom brace is movably coupled to the first panel along the first lower hinge line.

14. The portable display device of claim 12, wherein the second panel includes a second lower hinge line, and wherein the second bottom brace is movably coupled to the second panel along the second lower hinge line.

15. The portable display device of claim 12, wherein the portable display device comprises one piece of material, and wherein the one piece of material is rectangular such that the length of the first panel plus the first bottom brace is equal to the length of the third panel plus the footer.

16. The portable display device of claim 11, further comprising a marquee surface integral with the first and second panels and projecting away from the first and second panels.

17. The portable display device of claim 11, wherein the third panel includes a footer hinge line, and wherein the footer is movably coupled to the third panel along the footer hinge line.

18. A method of setting up a portable display device formed of a single piece of material, the method comprising:
folding a first panel of the material inwardly toward a center of the material along a first side hinge line;
folding a second panel of the material inwardly toward the center of the material along a second side hinge line;
extending a marquee surface away from the first and second panels in one of a first or a second direction;
extending a footer away from the first and second panels along a footer hinge line in the first direction;
extending a first bottom brace away from the first panel along a first lower hinge line in the second direction; and
extending a second bottom brace away from the second panel along a second lower hinge line in the second direction.

19. The method of claim 18, wherein extending the first and second bottom braces away from the first and second panels in the second direction includes extending the first and second bottom braces in a direction opposite to the first direction.
